(19) United States
(12) Patent Application Publication
(10) Pub. No.: US 2024/0075502 A1
(43) Pub. Date: Mar. 7, 2024

(54) Mattress Cleaning Device

(71) Applicant: Jiangsu Sea-lion Machinery Co., Ltd., Zhangjiagang City (CN)

(72) Inventors: Hong Chen, Zhangjiagang City (CN); Zhonghua Gu, Zhangjiagang City (CN); Shengang Cai, Zhangjiagang City (CN); Lunan Wang, Zhangjiagang City (CN); Yexin Li, Zhangjiagang City (CN); Wei Shen, Zhangjiagang City (CN)

(21) Appl. No.: 18/051,023

(22) Filed: Oct. 31, 2022

(30) Foreign Application Priority Data
Sep. 6, 2022 (CN) 202211084859.6

(51) Int. Cl. B08B 1/00; B08B 1/02; B08B 3/02

(52) U.S. Cl. CPC B08B 1/002; B08B 1/02; B08B 3/02

(57) ABSTRACT

The present invention discloses a mattress cleaning device including a conveying assembly, a first brush roller set, a second brush roller set, and a third brush roller set. Multiple groups of the conveying assemblies are arranged horizontally at intervals to form a conveying channel, and multiple alternate spaces are formed between the multiple groups of the conveying assemblies. The first brush roller set includes at least two movable brush roller rotatably arranged in multiple alternate spaces, and the moving brush rollers can move up and down relative to the conveying assembly in a direction perpendicular to the conveying channel so as to clean the front face and the rear face, and the lower face of a mattress. The second brush roller set is rotatably arranged above the conveying assembly to clean the upper end face of the mattress.

### TECHNICAL FIELD

The present invention relates to the field of mattress cleaning, and in particular to a mattress cleaning device.

### BACKGROUND ART

In the prior art, automated cleaning is not effectively achieved due to the generally large size of a mattress. In order to solve this problem, a patent for invention with the publication number CN112170302A discloses a mattress cleaning structure, which realizes a fully automatic brushing process of a mattress. However, the process is that the upper end face of the mattress, the front end face of the mattress, and two side end faces of the mattress are cleaned first, then the mattress is overturned by an overturning assembly, and then the lower end face and the rear end face of the mattress (turning to the upper end face and the front end face after the overturning) are cleaned. In addition, the weight of the soaked mattress increases dramatically, and the turnover mechanism tends to be unstable when the mattress is overturned, which may also cause damage to the turnover mechanism, resulting in the shutdown and maintenance of the whole automatic cleaning line.

The information disclosed in the background art is intended merely to enhance the understanding of the overall background art of the invention and should not be taken as an admission or any suggestion in any form that such information constitutes the prior art known to a person of ordinary skills in the art.

### SUMMARY OF THE INVENTION

An object of the present invention is to provide a mattress cleaning device capable of automatically cleaning the entire surface of a mattress at one time without overturning the mattress, with a high degree of automation and a good cleaning effect.

To achieve the above object, an embodiment of the present invention provides a mattress cleaning device including a conveying assembly, a first brush roller set, a second brush roller set, and a third brush roller set. Multiple groups of the conveying assemblies are arranged horizontally at intervals to form a conveying channel, and multiple alternate spaces are formed between the multiple groups of the conveying assemblies. The first brush roller set comprises at least two moving brush rollers. Multiple moving brush rollers are rotatably arranged in the multiple alternate spaces, and the moving brush rollers can move up and down relative to the conveying assembly in a direction perpendicular to the conveying channel so as to clean a front face, a rear face, and a lower end face of a mattress. The second brush roller set is rotatably arranged above the conveying assembly to clean an upper end face of the mattress; a third brush roller set is rotatably arranged on two sides of a transporting direction of the conveying assembly to wash end faces on two sides of the mattress.

In one or more embodiment of the present invention, the first brush roller set further comprises at least one first brush roller, wherein the first brush roller is rotatably provided within the alternate space, and a part of a surface of the first brush roller always protrudes above an upper surface of the conveying assembly during a rotation of the first brush roller to clean the lower end face of the mattress.

In one or more embodiment of the present invention, the distance between adjacent moving brush rollers is greater than or equal to the length or width of the mattress and at least one of the first brush rollers is provided between adjacent moving brush rollers.

In one or more embodiment of the present invention, each of the first brush rollers and each of the moving brush rollers extends in a width direction of the conveying channel.

In one or more embodiment of the present invention, the second brush roller set comprises multiple second brush rollers arranged in the transporting direction of the conveying assembly and offset from the moving brush roller.

In one or more embodiment of the present invention, each second brush roller extends in a width direction of the conveying channel.

In one or more embodiment of the present invention, the third brush roller set comprises multiple third brush rollers arranged in the transporting direction of the conveying assembly, each third brush roller extending in a moving direction of the moving brush roller.

In one or more embodiment of the present invention, the conveying assembly comprises a conveying shaft, a conveying belt, and a power structure, wherein the conveying belt is sleeved on the conveying shaft, and the power structure is connected to the conveying shaft to drive the conveying belt to rotate to drive the conveying belt to operate.

In one or more embodiment of the present invention, each of the first brush roller set, the second brush roller set, and the third brush roller set comprises a respective drive structure that drives a corresponding brush roller set to rotate or move to brush a surface of the mattress.

In one or more embodiment of the present invention, the mattress cleaning device further comprises a spray assembly comprising multiple spray pipes arranged above the conveying assembly to spray a mattress with detergent or clear water.

In one or more embodiment of the present invention, the mattress cleaning device further includes a cleaning tank having an enclosed space formed therein, and the conveying assembly, the first brush roller set, the second brush roller set, the third brush roller set, and the spray assembly are all provided within the enclosed space.

In one or more embodiment of the present invention, a water containing tank is provided in the cleaning tank below the conveying channel.

In one or more embodiment of the present invention, a water storage tank is provided above the cleaning tank, and the water storage tank is provided in communication with the spray assembly.

Compared with the prior art, the mattress cleaning device according to the embodiment of the present invention has a high degree of automation and a good cleaning effect by providing the first brush roller set, the second brush roller set, and the third brush roller set, and simultaneously washing the lower end face of the mattress, the front end face and the rear end face of the mattress, the upper end face of the mattress, and the end faces on two sides of the mattress respectively, and automatically cleaning the entire surface of the mattress at one time without overturning the mattress.

### BRIEF DESCRIPTION OF THE DRAWINGS

FIG. 1 is a schematic perspective view showing a mattress cleaning device according to an embodiment of the present invention;

FIG. 2 is a cross-sectional view of a mattress cleaning device according to an embodiment of the present invention;

FIG. 3 is an enlarged detailed view of a structure of part A of FIG. 2.

### DETAILED DESCRIPTION OF THE INVENTION

The specific embodiment of the present invention is described in detail below in combination with the drawings, but it should be understood that the scope of protection of the present invention is not limited by the specific embodiment.

Unless otherwise expressly stated, in the entire specification and claims, the term “including” or its transformations such as “comprising” or “comprises” will be understood to include the stated elements or components, without excluding other elements or other components.

The mattress cleaning device in the prior art cannot clean six surfaces of a mattress at the same time, but needs to first clean some of the end faces, and then uses a turnover mechanism to turn over the mattress during the cleaning process, so as to achieve the purpose of cleaning the remaining end faces; the cleaning process is tedious, and the mattress after absorbing water is easy to cause damage to the turnover mechanism, thus increasing the cost of shutdown and maintenance.

In order to solve this technical problem, the present invention provides an inventive mattress cleaning device, which can achieve the simultaneous cleaning of six end faces while moving the mattress on the conveying assembly by providing a first brush roller set for cleaning the lower end face, the front end face, and the rear end face between multiple sets of conveyor assemblies for transporting the mattress. A second brush roller set is provided for cleaning the upper end face above the conveying assembly, and a third brush roller set is provided for cleaning the left face and the right face on two sides of the conveying assembly.

In combination with a specific embodiment and the accompanying drawings, the specific embodiment of the mattress cleaning device of the present invention is described in detail below.

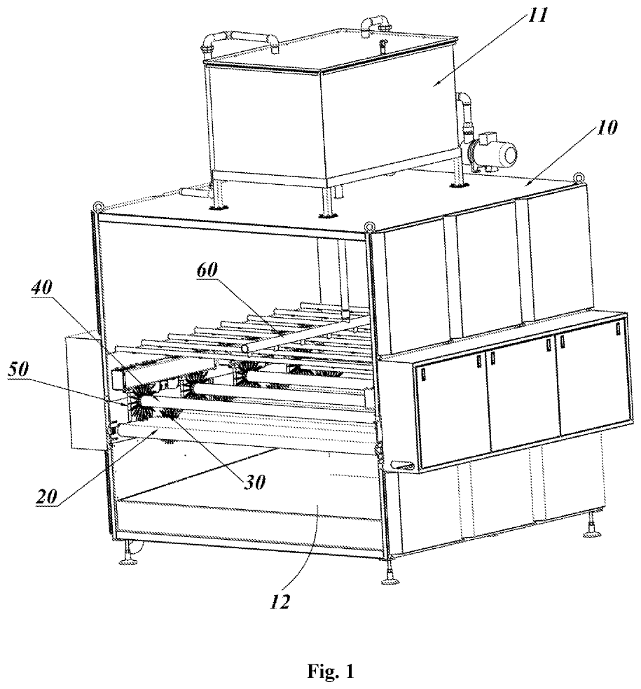

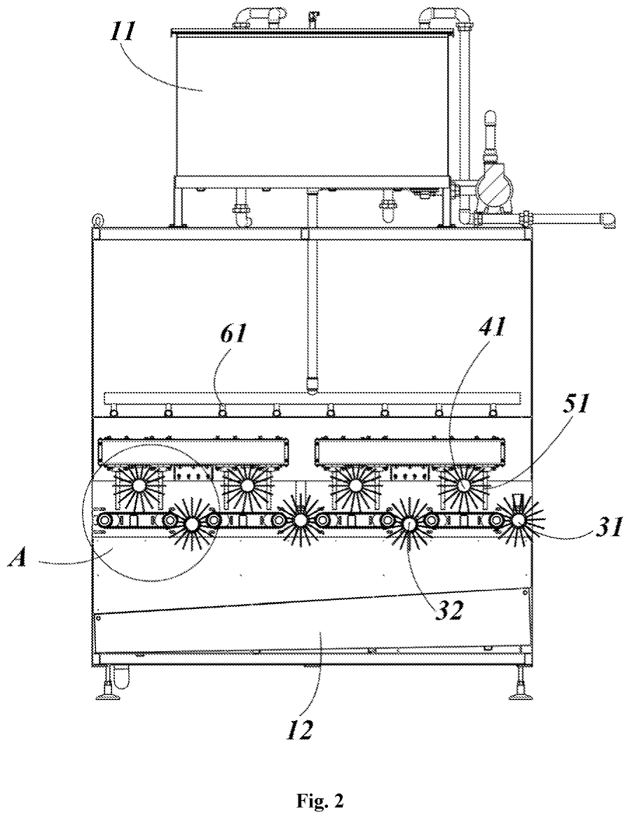

As shown in FIGS. 1 to 3, a mattress cleaning device according to an embodiment of the present invention includes a cleaning tank 10, a conveying assembly 20, a first brush roller set 30, a second brush roller set 40, a third brush roller set 50, and a spray assembly 60. The conveying assembly 20, the first brush roller set 30, the second brush roller set 40, the third brush roller set 50, and the spray assembly 60 are all arranged in the cleaning tank 10. The conveying assembly 20 is used for the transportation of the mattress. The first brush roller set 30 is used for washing the front face, the rear face and the lower end face of the mattress. The second brush roller set 40 is used for washing the upper end face of the mattress; the third brush roller set 50 is used for washing end faces on two sides of the mattress.

In this embodiment, the cleaning tank 10 is constructed as a closed box structure. The cleaning tank is provided on two sides thereof with doors that can be opened and closed. The door is driven by a vertical cylinder so that the mattress cleaning device of the present invention can be used with other cleaning systems, such as subsequent rinsing devices, drying devices, etc. The openable and closable door also allows the cleaning tank 10 to have an independent cleaning space. The water stains during cleaning will not splash into the environment or other cleaning systems.

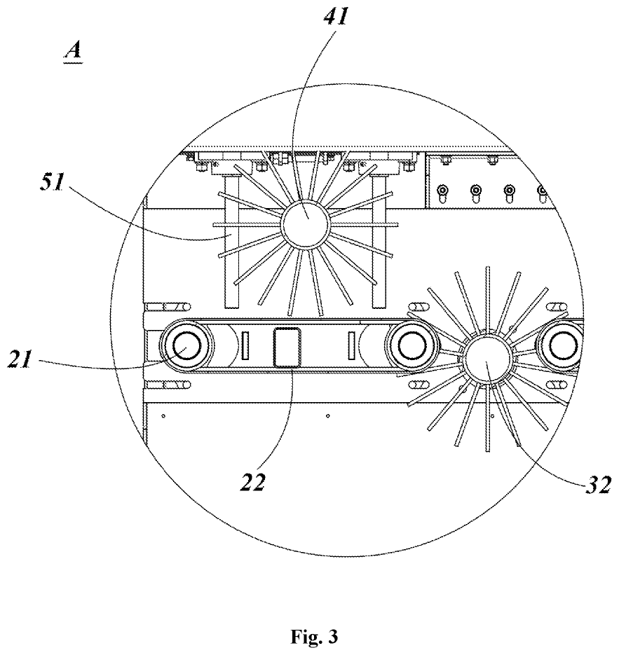

Multiple groups of conveying assemblies 20 are horizontally spaced and arranged in the cleaning tank 10 and are located between two openable and closable doors to form a conveying channel. Multiple alternate spaces are formed between multiple groups of conveying assemblies 20. Preferably, one alternate space is formed between adjacent conveying assemblies 20. The conveying assembly 20 comprises a conveying shaft 21, a conveying belt 22, and a power structure. The conveying belt 22 is sleeved on the conveying shaft 21, and the power structure is connected to the conveying shaft 21 to drive the conveying shaft 21 to rotate so as to drive the conveying belt 22 to operate so as to move and transport the mattress, as shown in FIG. 3.

The first brush roller set 30 includes multiple movable brush rollers 31 and one or more first brush rollers 32, and the movable brush rollers 31 and the first brush rollers 32 are rotatably provided in multiple alternate spaces, respectively. The distance between adjacent moving brush rollers 31 is greater than or equal to the length or width of the mattress, and at least one first brush roller 32 is provided between adjacent moving brush rollers 31. The movable brush roller 31 is movable up and down in a direction perpendicular to the conveying channel with respect to the conveying assembly 20 to wash the front face and the rear face of the mattress at the same time. When the movable brush roller 31 moves to be flush with or slightly lower than the converting assembly 20, it can also assist in cleaning the lower end face of the mattress. The first brush roller 32 serves to wash the lower end face of the mattress, and a part of the surface of the first brush roller 32 is always convex to the upper surface of the conveying assembly 20 during the rotation of the first brush roller 32 to wash the lower end face of the mattress. In the present embodiment, the movable brush roller 31 and the first brush roller 32 each comprise a roller body and a brush provided on the surface of the roller body for brushing the mattress, i.e. when the first brush roller 32 is provided, the roller body thereof needs to be always lower than the upper surface of the conveying assembly 20, but the brush on it needs to protrude slightly above the upper surface of the conveying assembly 20 so as to contact and brush the surface of the mattress. Each first brush roller 32 and each movable brush roller 31 is extended in the width direction of the conveying channel, and the extending length is preferably greater than or equal to the width of the conveying channel (greater than or equal to the length or width of the mattress) so that the first brush roller 32 and the movable brush roller 31 can completely wash the respective entire end faces when the mattress is moved on the conveying belt 22.

The second brush roller set 40 is rotatably provided above the conveying assembly 20 to clean the upper end face of the mattress. The second brush roller set 40 includes multiple second brush rollers 41 arranged in line in the transporting direction of the conveying assembly 20 and offset from the movable brush roller 31 such that the movable brush roller 31 does not interfere with the second brush roller 41 when moving up and down. In order to improve the cleaning effect, at least one second brush roller 41 is correspondingly provided directly above each conveying assembly 20. Each second brush roller 41 is likewise provided to be extending in the width direction of the conveying channel.

The third brush roller set 50 is rotatably provided at two sides in the transporting direction of the conveying assembly 20 to wash two sides faces of the mattress. The third brush roller set 50 comprises multiple third brush rollers 51 arranged in the transporting direction of the conveying assembly 20, and each third brush roller 51 is arranged to extend in the moving direction of the movable brush roller 31 by an extending length greater than or equal to the thickness of the mattress.

In this embodiment, the second brush roller 41 and the third brush roller 51 also comprise a roller body and a brush provided on the surface of the roller body for brushing the mattress, the self-rotation of the roller body driving the surface brush to brush the mattress.

Because the thicknesses and sizes of the mattresses vary, the brush roller needs to adapt thereto. Therefore, the brush roller is typically movably mounted within the cleaning tank 10 to fit the surface of the mattress. In this embodiment, the first brush roller 32 and the second brush roller 41 need only to be mounted on a sliding block that is movable up and down perpendicular to the transporting direction of the conveying assembly 20 so as to monitor and contact the mattress to begin brushing via a sensor. Since the third brush roller 51 is used for brushing end faces on two sides of the mattress, if the width of the mattress becomes small, it is necessary to bring the third brush rollers 51 on two sides close to each other, and the movement of the third brush roller 51 can also be achieved by means of a sliding block and a sliding rod. Such kind of moving mode can adopt the existing technology, which will not be described in detail herein.

In this embodiment, the first brush roller set 30, the second brush roller set 40, and the third brush roller set 50 each includes a corresponding drive structure that drives the corresponding brush roller set to rotate or move to brush the surface of the mattress. Preferably, the first brush roller set 30 and the second brush roller set 40 self-rotate in the same direction to improve the stability of the mattress during moving cleaning. If the self-rotation is reversed and the mattress is relatively near the front, the first brush roller set 30 and the second brush roller set 40 can easily continue to push the mattress forward.

In a specific embodiment, the number of the conveying assemblies 20 is four, thereby forming a total of five alternate spaces. The number of the first brush rollers 32 is two, and the number of the movable brush rollers 31 is two, which are respectively arranged in the above-mentioned five alternate spaces, and the moving brush rollers 31 and the first brush rollers 32 are arranged at intervals in a staggered manner; for example, one end of the conveying assembly 20 is provided with one movable brush roller 31 and the other end is provided with one first brush roller 32. The number of the second brush rollers 41 is four, corresponding to four conveying assemblies 20, respectively. The number of the third brush rollers 51 is 16, which are respectively arranged on two sides of the second brush roller 41, and one second brush roller 41 corresponds to four third brush rollers 51. In some other embodiments, the number of brush rollers may be adapted as desired, which will not be limited herein.

The spray assembly 60 includes multiple spray pipes 61 arranged above the conveying assembly 20 to spray the mattress with detergent or clear water. A water storage tank 11 is provided above the cleaning tank 10, and the water storage tank 11 is provided in communication with the spray assembly 60. In order that the cleaned sewage does not contaminate the environment or the tank, a water containing tank 12 is provided in the cleaning tank 10 below the conveying channel. The projection of the conveying assembly 20 in the vertical direction falls partially or entirely within the water containing tank 12. The bottom of the water containing tank 12 is inclined with respect to the ground to facilitate the discharge of sewage.

The mattress enters the conveying assembly 20 in the cleaning tank 10; the brush roller set in the cleaning tank 10 brushes the mattress; when the mattress is washed, a diluent with a detergent is sprayed from the spray pipe 61 according to needs; through the movement of the conveying belt, the first brush roller set 30 is used to brush the lower end face and the front end face and the rear end face of the mattress, the second brush roller set 40 is used to brush the upper end face of the mattress, and the third brush roller set 50 is used to brush the end faces on two sides of the mattress. In this embodiment, the brush roller set may be driven to rotate to brush the surface of the mattress. In other embodiments, the brush roller set may not actively rotate, and the mattress is conveyed back and forth by the conveying assembly 20 so as to rotate the brush roller set to brush the surface of the mattress, thereby achieving full cleaning of the six sides of the mattress.

Compared with the prior art, the mattress cleaning device according to the embodiment of the present invention has a high degree of automation and a good cleaning effect by providing the first brush roller set, the second brush roller set, and the third brush roller set, and simultaneously washing the lower end face of the mattress, the front end face and the rear end face of the mattress, the upper end face of the mattress, and the end faces on two sides of the mattress respectively, and automatically cleaning the entire surface of the mattress at one time without overturning the mattress.

The foregoing description of specific exemplary embodiment of the present invention is for purposes of illustration and examples. The description is not intended to limit the invention to the precise form disclosed, and it is clear that many changes and variations can be made according to the above teachings. The purpose of selecting and describing exemplary embodiments is to explain the specific principles and practical applications of the invention so that those skilled in the art can realize and utilize various exemplary embodiment of the invention, as well as various choices and changes. The scope of the invention is intended to be defined by the claims and equivalents thereof.

What is claimed is:

1. A mattress cleaning device, comprising:
multiple groups of a conveying assembly arranged horizontally at intervals to form a conveying channel, wherein multiple alternate spaces are formed between the multiple groups of the conveying assemblies;
a first brush roller set comprising at least two moving brush rollers, wherein multiple moving brush rollers are rotatably arranged in the multiple alternate spaces, and the moving brush rollers are capable of moving up and down relative to the conveying assembly in a direction perpendicular to the conveying channel so as to clean a front face, a rear face, and a lower face of a mattress;
a second brush roller set rotatably arranged above the conveying assembly to clean an upper end face of the mattress; and
a third brush roller set rotatably arranged on two sides of a transporting direction of the conveying assembly to wash end faces on two sides of the mattress.

2. The mattress cleaning device of claim 1, wherein the first brush roller set further comprises at least one first brush roller, wherein the first brush roller is rotatable within the alternate space, and a part of a surface of the first brush roller always protrudes above an upper surface of the conveying assembly during a rotation of the first brush roller to clean the lower end face of the mattress.

3. The mattress cleaning device of claim 2, wherein a distance between adjacent moving brush rollers is greater than or equal to a length or a width of the mattress and at least one of the first brush rollers is provided between adjacent moving brush rollers.

4. The mattress cleaning device of claim 2, wherein each of the first brush rollers and each of the moving brush rollers extend in a width direction of the conveying channel.

5. The mattress cleaning device of claim 1, wherein the second brush roller set comprises multiple second brush rollers arranged in the transporting direction of the conveying assembly and offset from the moving brush roller.

6. The mattress cleaning device of claim 5, wherein each second brush roller extends in a width direction of the conveying channel.

7. The mattress cleaning device of claim 1, wherein the third brush roller set comprises multiple third brush rollers arranged in a transporting direction of the conveying assembly, each third brush roller extending in a moving direction of the moving brush roller.

8. The mattress cleaning device of claim 1, wherein the conveying assembly comprises a conveying shaft, a conveying belt, and a power structure, wherein the conveying belt is sleeved on the conveying shaft, and the power structure is connected to the conveying shaft to drive the conveying belt to rotate to drive the conveying belt to operate.

9. The mattress cleaning device of claim 1, wherein each of the first brush roller set, the second brush roller set, and the third brush roller set comprises a respective drive structure that drives a corresponding brush roller set to rotate or move to brush a surface of the mattress.

10. The mattress cleaning device of claim 1, further comprising a spray assembly comprising multiple spray pipes arranged above the conveying assembly to spray a mattress with detergent or clear water.
